(19) United States
(12) Patent Application Publication
(10) Pub. No.: US 2009/0022941 A1
(43) Pub. Date: Jan. 22, 2009

(54) SELF-ADHESIVE ELEMENT

(75) Inventors: Wolf-Joachim Fischer, Dresden (DE); Reinhard Boden, Dresden (DE); Daniele Wiedemuth, Dresden (DE)

Correspondence Address: BARNES & THORNBURG LLP, 11 SOUTH MERIDIAN, INDIANAPOLIS, IN, 46204, US

(73) Assignee: Fraunhofer-Gesellschaft zur Forderung der angewandten Forschung e.V., Munich (DE)

(21) Appl. No.: 12/121,966

(22) Filed: May 16, 2008

(30) Foreign Application Priority Data
May 18, 2007 (DE) 10 2007 024 238.9

(51) Int. Cl. B32B 3/12; B32B 5/00

(52) U.S. Cl. 428/116; 428/141

(57) ABSTRACT

The invention relates to self-adhesive elements which can be fastened to the most varied adhesive bodies and can be used for the most varied applications. It is the object of the invention to propose elements which can be fastened in a self-adhesive manner to the different adhesive bodies, with the fastening having to be possible in a detachable manner and a multiple use of the elements being possible. At least one sensor/pickup, an electronic element, an optoelectronic element and/or an actuator are present in a self-adhesive element in accordance with the invention. Elastically deformable pimple-shaped elevated portions are formed at a surface of the element to which an adhesive body can be connected in a self-adhesive and detachable manner. The surface of the pimple-shaped elevated portions is spherically curved at least in the region which is in touching contact with the adhesive body.

The invention relates to self-adhesive elements which can be fastened to adhesive bodies. As a result of the self-adhesive fastening, the elements in accordance with the invention can naturally also be detached from the adhesive body again. The elements in accordance with the invention could also be called sensor elements and could be used as such.

The elements in question can be used with sensors and, optionally, with electronics integrated in line with the application, pick-ups, actuators in connection with different adhesive bodies. There is thus the possibility of a self-adhesive fastening as an extracorporeal sensor having direct contact with the body on human or animal skin, but also on other objects. A self-adhesive fastening is, however, also possible on textile materials or similar flexible materials such as foils as well as also on rigid adhesive bodies respectively having the most varied surface properties.

Possible areas of use are medical diagnostics and therapy. However, a use is also possible for the detection of local movements of the skin, the musculature and, in so doing, also during the movement of a human or animal (vital parameters), in working life (e.g. protective clothing and safety clothing) or during sports and wellness as well as in the leisure area (smart clothing).

A self-adhesive element can thus replace and functionally expand an electrode which, in the form of a dry electrode or of an adhesive electrode, has previously been fastened to bodies with the help of adhesives causing residues or other additional, permanently acting pressing means such as belts or additional external suction devices. Telemonitoring is also possible for the long-term monitoring of vital parameters such as ECG sensors, EMG sensors, EOG sensors, temperature sensors, photoplethysmographs, pulsoximeters, positional sensors and breathing exertion sensors or also for photodynamic therapy or electrical stimulation of muscles or nerves or also defibrillation (physical therapy). It can also be used for a transcutaneous monitoring of blood gases, e.g. on a partial pressure measurement of oxygen and carbon dioxide.

In this connection, the self-adhesive elements can be placed on different parts of the body, in particular also for photoplethysmography.

Furthermore, metabolic parameters can also be determined with the help of a self-adhesive element.

An example for this is optical glucose measurement over a suitable wavelength.

The self-adhesive element moreover provides the possibility of determining the pulse wave as a pressure parameter, and of thus determining the pulse pressure and/or blood pressure, at any sites of a body.

A reservoir for pharmaceutical active ingredients, drugs or other liquids can also be present in the self-adhesive element. In this connection, an injection connection to blood vessels or for a transcutaneous, subcutaneous or percutaneous therapy can be included. A fastening of an insulin pump can thus also be possible.

The detachable fastening of the self-adhesive element in adhesive prosthetics (e.g. control of orthopedic limbs) with a pick-up and/or actuator function is a further wide area of application.

In addition, a use of the self-adhesive element is also given for the monitoring/diagnosis of e.g. portable parts or machines, units, means of transport and buildings, etc.

An element in accordance with the invention can e.g. be integrated easily and unobtrusively on patients and/or in textile material/flexible materials (smart clothes). The completely new sensor application sites on the human body associated with this have the result, for example in photoplethysmography or pulsoximetry, that the measurement no longer only has to take place at the extremities of a patient or result in a substantial weight saving in smart prosthetics.

The flexibility of the self-adhesive elements permits an individual fitting to the body on an electrical and/or optical coupling as required without slipping so that the coupling conditions (e.g. impedance) remain unchanged.

An element in accordance with the invention can communicate in both a wireless and wired manner with further elements adhering to the body or to other objects and/or with the electronic and can be a component of a composite unit. The wearing comfort is very high due to the flat and flexible design possibility. The self-adhesive biocompatible element is reusable, easy to clean as well as washable and able to be disinfected. The functional properties and quality characteristics are maintained during the cleaning and disinfection processes even with the high chemothermal and mechanical stresses.

The element in accordance with the invention can be realized as a low-cost element and thus also suitable as a mass product with high reliability and service life e.g. as an individual sensor or in interconnection e.g. as an extracorporeal sensor system as well as a sensor in connection with other objects and very largely independently of the environmental conditions.

As already indicated, in medical applications, ECG electrodes are either stuck directly onto the skin on the body as an adhesive electrode or are placed on under the exertion of external pressure as a dry electrode made of metal or of a conductive polymer and are thus fastened. Additional suction pads generally require an external unit to generate the negative pressure.

A long-term application is only possible with limitations in these cases and impaired by unwanted side effects. The adhesive capability of an adhesive which is used drops after a certain time. Adhesive residues are also unwanted and can cause skin irritations or allergies since they can frequently only be removed with difficulty. A use in which a humidity influence can also occur, e.g. showering, bathing or swimming, is not possible with the known technical solutions. Water influence thus inter alia reduces the adhesive ability of adhesive electrodes and changes the impedance conditions with dry electrodes.

The dry electrodes have to be fastened using belts or other holders to be able to ensure a sufficiently high contact pressure in the long term. This can have a disturbing effect for the organism due to the intolerable long-term pressure and causes a great impairment of the wearing comfort even up to physical pain.

The high contact pressure is required so that the leakage currents, e.g. for an ECG or other transcutaneal continuous measurements, can be led permanently and reliably from the patient to the electronics.

Suction systems with a constant external negative pressure generation cause pathological trandsudates (hemotomas), are space-intensive and unsuitable under dynamic conditions (e.g. leakage of body currents in the moving state of a human).

Suction heads without external negative pressure generation can easily snap off from the adhesive body so that a long-term adhesion cannot be achieved.

Patches do not satisfy the demands on an adhesive system of an element with a sensor function either as disposable articles or due to their adhesive residues.

The sufficiently known hook and loop fasteners of fleece material and hook material cannot be used in a number of cases since only the two complementary parts can in each case be brought into connection with one another.

A smart button element is described in DE 10 2006 039 587 (not prepublished) which can also contain electrodes in addition to electronics. It can be directly integrated in a textile material, but does not have any self-adhesive properties.

A washable flat electronic system having free connection contacts for integration into a textile material or flexible material such as is described in DE 10 2007 002 323 (likewise not prepublished) likewise does not have the required self-adhesive capability.

To ensure self-adhesion and high functional reliability, elements are needed which adhere to any desired bodies without constant pressure, e.g. by fastening bands, or without additional aids (e.g. external negative pressure generation for suction heads) and which can be detached again without residue. Furthermore, in addition to the flexibility of the element, a certain stability should also be ensured for shape maintenance. In addition, the function-defining electrical, electronic, optoelectronic components integrated in the element should be able to be electrically conductively connected to the adhesive body.

An element should be able to be manufactured as simply as possible and should have long-term reliability and should ensure the electrical and mechanical protection of all functional units even under high stress during its operation and on cleaning or disinfecting with hot/cold fluctuations, at high humidity, with body perspiration, the influence of water, atmospheric influences as well as with vibrations and blows.

For instance, an electrode element for a suction electrode is known from DE 203 08 658 U1, the latter having an electrode element.

DE 44 04 842 A1 relates to a unit for antipuriginous electrotherapy.

It is therefore the object of the invention to propose elements which can be fastened in a self-adhesive manner to the different adhesive bodies, with the fastening having to be possible in a detachable manner and a multiple use of the elements being possible.

In accordance with the invention, this object is solved by an element having the features of claim 1. Advantageous embodiments and further developments of the invention can be achieved using features designated in the subordinate claims.

Elements in accordance with the invention are designed such that they can be fastened in a self-adhesive manner to adhesive bodies and such that the fastening is detachable. Additional permanent contact pressure can be dispensed with in this connection. At least one sensor/pick-up, an electronic element, an actuator and/or another element is/are present at the element in accordance with the invention. In addition, at least one surface should be present which is equipped with elastically deformable, pimple-shaped elevated portions which again adopt their starting position and starting shape after the detachment of the self-adhesive connection from the respective adhesive body. The surface of the pimple-shaped elevated portions is spherically curved at least in the region which is brought into touching contact with the respective adhesive body. Such a curvature can preferably be spherical, or also follow an ellipse or other convex or concave shapes.

The element in accordance with the invention having the elastically deformable pimple-shaped elevated portions should be designed such that at least the pimple-shaped elevated portions or portions in form of a knob or nep are made using a material which has viscoelastic, thixotropic or elastomeric properties. An interface layer can be formed at the surface of pimple-shaped elevated portions and ensures the reproducibility of the adhesive behavior and the shape stability and positional stability of the pimple-shaped elevated portions via its surface tension.

Elastically viscous material of pimple-shaped elevated portions should have a sufficiently large viscosity and thus a correspondingly large internal friction which effects the viscosity.

With pimple-shaped elevated portions or portions in form of a knob or nep of thixotropic material, which can embody a non-Newtonian fluid, its viscosity varies with the deformation of the e.g. gel-like pimple-shaped elevated portions under influencing, changing shear forces as a reversible procedure. In the state of rest, i.e. after the detachment of the pimple-shaped elevated portions from the adhesive body, the starting viscosity builds up again in a relaxing manner.

Elastomeric pimple-shaped elevated portions deform with the deformation forces which occur and then return back to the original non-deformed design, with the elastomer taking the energy required for this from the ambient heat by Brownian molecular movement.

The pimple-shaped elevated portions can be provided with special coupling and functional properties; they can, for instance, contain filler particles held together by cohesion or be filled with filler materials (e.g. special viscous materials, gels, air, dye, et al.) and fillers and the interface layer can be electrically conductively doped. Special properties can thereby be defined locally or point-wise, in particular established for contacting and influence can also be taken on the hardness, viscosity and elasticity.

Pimple-shaped elevated portions and/or their carrier layer can e.g. be made of or also with silicone or polyurethane. In this connection, unevenness of an adhesive body can be equalized easily and flexibility and optical transparency can simultaneously be ensured.

A termination of pimple-shaped elevated portions by interfaces with reproducible properties can make possible a stable thermal conductivity, which is adjustable together with a filling, so that a thermal conductivity to a sensor/pick-up can also be achieved and thereby e.g. a temperature measurement can be carried out.

The self-adhesive properties on organic or inorganic surfaces of adhesive bodies can be achieved over the whole surface with a simultaneously possible aeration with the surface of pimple-shaped elevated portions or their interface layers which have viscoelastic, thixotropic or elastomeric properties and which can also be made as a skin or as an envelope or covering.

Pimple-shaped elevated portions can be formed directly at a carrier layer or can preferably be fastened thereto in a non-detachable manner. It follows from this that pimple-shaped elevated portions and the carrier layer can also be made from the same material. The carrier layer is thereby also equipped with elastic properties and can be deformed accordingly.

To ensure a flexibility, a lightweight construction and a sufficient stability of the carrier layer, it can be made in foil form, but also in net form, mesh form, honeycomb form or with other geometrical shapes, whereby a stabilizing framework can be formed in whose free spaces pimple-shaped elevated portions can advantageously be accommodated.

Spherically curved pimple-shaped elevated portions effect suction processes on the contact with the surface of adhesive bodies by which a negative pressure is formed on the deformation of the pimple-shaped elevated portions between the adhesive body and the surface of pimple-shaped elevated portions. In addition, the adhesion is amplified since intermolecular adhesion forces which can come into effect as an attractive force between the atoms or molecules on their contact can act at the interfaces between the surface of pimple-shaped elevated portions and the surface of an adhesive body. The contacting surfaces are kept practically static in this manner and a certain degree of static friction can also be utilized in addition to the suction effect. The bringing about of the surface tension and of the adhesion as interface phenomena at phase interfaces results from the Van der Waals force which occur between molecules, in generally homopolar molecules, and enter into electrostatic interactions with one another which results in mutual adhesion of pimple-shaped elevated portions and adhesive bodies.

In this manner, pimple-shaped elevated portions form partial adhesion elements whose suction and adhesion behavior can be influenced by the shape of the spherical curvature, whereby both the suction behavior can dominate in amplified manner with a concave curvature and the adhesion behavior can dominate in amplified manner with a convex curvature. The air volume displaced on the deformation of the pimple-shape elevated portions or the contact surface between pimple-shaped elevations and the adhesive body is decisive for the respective dominance.

A relatively secure coupling of an element in accordance with the invention to bodies or objects as adhesive bodies can be achieved while utilizing these effects.

In particular convexly shaped pimple-shaped elevated portions increase the adhesion-caused adhesion force effect by increasing the contact regions on their deformation and this results in an enlarging of the contact surface between the pimple-shaped elevated portion and the respective adhesion body. With concavely shaped pimple-shaped elevated portions, this adhesive effect only occurs when the concave arching has flattened to a very high degree.

Adhesive forces can furthermore be increased without residue in that the interfaces of pimple-shaped elevated portions are provided with very fine hairs. The Van der Waals force is thereby amplified. In this context, a very large number of such hairs have an effect of increasing adhesion. However, a counterpiece, that is likewise hairs or similar elements at the surface of the respective body, is not required in this connection.

As a result of the elasticity, an element in accordance with the invention can be adapted to the respective surface contour of the adhesive body so that a self-adhesive fastening is also possible easily and also in long-term form at concavely or convexly curved surfaces. When placing an element in accordance with the invention onto an adhesive body, a deformation of the surface of at least the pimple-shaped elevated portions preferably occurs in the form of a concave basic arching. The pimple-shaped elevated portions as partial adhesion elements can have convex and/or concave curvatures inside this concave basic arching. After the lifting off or detachment of the element from the adhesive body, the pimple-shaped elevated portions and frequently also the remaining parts of an element again adopt their starting shape. Hysteresis phenomena can be excluded to a very high degree. No residues remain on the surface of an adhesive body after the detaching.

The pimple-shaped elevated portions again adopt their original/starting shape after the detaching of the adhesive connection, with this being the case with pimple-shaped elevated portions having elastically viscous material, thixotropic material or also elastomeric material.

Pimple-shaped elevated portions can be arranged at spaces from one another in which no mutual contact occurs. The spacings can, however, also be selected such that pimple-shaped elevated portions arranged next to one another contact one another. Intermediate pimple chambers can thereby be formed between pimple-shaped elevated portions, at least when they are fastened to an adhesive body. An additional suction force effect can thereby be achieved. When an element in accordance with the invention is pressed or placed onto an adhesive body, intermediate pimple chambers are compressed so that air escapes. The adhesive effect can be further increased with the negative pressure obtained in this manner. On the deformation of pimple-shaped elevated portions being in touching contact by an axial force effect on the adhesive boy, the intermediate pimple chambers having a suction head or suction pad respectively closed in themselves are formed and/or sealed by the pimple-shaped elevated portions being subjected to radially acting force effect on the deformation. In this connection, these additional suction heads having the pimple-shaped elevated portions can form a tight adhesive force network over the whole surface by the additional suction and adhesive forces.

In this connection, the starting root/base surface of pimple-shaped elevated portions can have prismatic, circular, elliptical or any other desired shapes.

With tightly connecting pimple-shaped elevated portions preferably connected continuously in a firmly bonded manner, the contact surfaces can form a carrier layer or a carrier frame so that these elements do not have to be present separately since it can be achieved by suction components and adhesive force components.

Intermediate pimple chambers can also be made with cut-outs for aeration.

Mechanical and also electrical properties can advantageously be influenced by a hybrid arrangement, that is, in addition to convex pimple-shaped elevated portions also with concave pimple-shaped elevated portions. Convex pimple-shaped elevated portions can achieve a reproducible electrical contact and high adhesive forces on deformation by suitable doping. With a concave curvature, suction forces dominate and adhesive forces in particular only come into effect on a contact of the base of the suction head with the adhesive body.

The total adhesive force results from the sum of all partial suction forces and adhesive forces, with only suction forces acting in the intermediate pimple chambers.

The self-adhesive effect results from the sum of the individual effects which merge into one another on an immediate adhesion of the element to the adhesive body.

Possible arrangements for pimple-shaped elevated portions are row arrangements, also in lines and columns as an array. Ring-shaped or rosette-shaped arrangements are likewise possible, with combinations thereof also being able to be chosen to achieve locally different properties and/or adhesive effects. In this connection, an influence can also be taken by the number and size of the pimple-shaped elevated portions and by intermediate pimple chambers.

As already mentioned, it may be desired and advantageous for a number of cases of use to be able to establish an electrically conductive connection between the element and the surface of adhesive bodies. For this purpose, at least pimple-shaped elevated portions can be electrically conductive. In this connection, pimple-shaped elevations can be doped with an electrically conductive material. Such a doping can be achieved, for example, by electrically conductive particles, for example graphite particles, with the pimple-shaped elevated portions also being able to have additional contacts with a shape matching and/or force transmitting effect which are embedded therein.

Starting from the respective surface of an adhesive body onto which an element in accordance with the invention has been self-adhesively applied, an electrically conductive connection can thereby be established to other elements such as sensors, electronic elements, electrodes, actuators or also electrical conductor tracks via the electrically conductive pimple-shaped elevated portions.

Pimple-shaped elevated portions also permit a local contact directly to integrated electronic elements. In this connection, pimple-shaped elevated portions doped in an electrically conductive manner and/or a carrier layer can be contacted by electrically conductive adhesive, shape matched and/or force transmitting contacts with associated electronic elements, electrodes, actuators and/or sensors/pick-ups, etc. For this purpose, the contact sites of electronic components can be connected to the electrically conductive pimple-shaped elevated portions or such sections of a carrier layer or can be surrounded by them or also brought into contact therewith in a couplable manner. Contacts can be connected to a carrier layer and/or pimple-shaped elevated portions in a detachable and/or non-detachable manner and can be connected to corresponding mating contacts.

There is, however, also the possibility that a carrier layer is likewise electrically conductive, at least regionally, which can likewise be achieved with a doping as described above. In this connection, not all the pimple-shaped elevated portions of a carrier layer can be made electrically conductive, but rather also selected pimple-shaped elevated portions or only selection regions of a carrier layer.

Contact elements can e.g. have a platelet, cylindrical or pimple-shaped design and can be adapted to and also integrated in a respective carrier element, pimple-shaped elevated portions and/or a carrier layer. A connection can be achieved by adhesive bonding, grouting, vulcanization or also by pressing.

With a copper lamination present on the carrier layer, it can be used directly for a contacting.

With electrically conductive pimple-shaped elevated portions, redundant arrangements can also be achieved in the most varied geometrical arrangements, as already addressed above, to increase the contact reliability.

With electrically conductive pimple-shaped elevated portions arranged perpendicular with respect to an electrode, the construction size of an element can be reduced by such a vertical arrangement.

If a vibration pick-up is present at an element in accordance with the invention, e.g. for non-medical monitoring, electrically conductive pimple-shaped elevated portions and a contact can be dispensed with.

With an arrangement of electrodes or sensors/pick-ups arranged laterally next to pimple-shaped elevated portions (horizontal arrangement), special impedance demands can be satisfied by their direct contact with the adhesive body.

With a combination of these arrangement possibilities, separate contact functions to the adhesive body and e.g. to the electronic element can be satisfied.

With at least one pimple-shaped elevated portion which can be guided over the total external periphery, following the outer rim contour of an element in accordance with the invention, and can thereby form an outer closed rim, a sealing with respect to the environment and thus also a protection against moisture can be achieved in a state placed on an adhesive body.

In addition to the already mentioned electronic elements, including optoelectronic units, other functional elements, for example, microsystem engineering, micromechanical, microfluidic micropneumatic functional elements, or a radio module for a wireless data transmission can be present at an element in accordance with the invention. This can be the case in integrated form, but also on a separately present circuit board, provided with vias for this purpose, on a contact site or also to an application-specific integrated circuit (ASIC).

It is likewise favorable for a number of application cases to surround sensors/pick-ups, electronic elements or other further elements which can be used in connection with an element in accordance with the invention in a housing. Hermetic protection can be achieved with such a housing, with functional elements being able to be sealed by additional layers, in particular with respect to moisture protection. Such a housing can be formed with protective foils, an encapsulation or by grouting.

An adaptation to the respective application with respect to the desired functions and modifications can take place by a functional separation of the element in accordance with the invention. In this connection, component integration, miniaturization, lightweight construction and a shallow design can be achieved in practically any desired form. This results in a basic structure in which electronic elements, sensors/pick-ups, actuators, etc. are arranged remote from the pimple-shaped elevated portions.

There is thus also the possibility with an element in accordance with the invention to arrange sensors/pick-ups, electronic elements such as control electronics and/or evaluation electronics or others such as actuators for the medical prosthetics on the carrier which can then be connected to the element in a firmly bonded manner or also in a shape matched and/or force transmitting manner. A replacement can thereby take place relatively simply, which can be necessary, for example, on an impairment of the functionality of electronic elements or also for a use in another application. Such a connection can be achieved, for example, in that an outer rim of a carrier is introduced within a groove formed at the element. A shape matched connection can thus be established. As a result of elasticity of the element also in the region of the groove or as a result of an elastic deformability of a carrier, a force transmitting connection can additionally be used in such a connection.

Elements in accordance with the invention can thus be plugged together, with then a textile part also optionally being able to be jammed therebetween. Sensors/pick-ups and/or actuators can also be arranged in a replaceable manner and have electrical and mechanical interfaces.

However, at least one electrode can also be present at an element in accordance with the invention and can in turn be brought into touching contact with the adhesive body for a specific application so that an electrically conductive connection is also established here, starting from the surface of an adhesive body, for example the skin of a human or of an animal. There is, however, also the possibility of connecting one or more such electrodes in an electrically conductive manner using pimple-shaped elevated portions and/or electrical conductors. Pimple-shaped elevated portions and electrodes can, in this connection, be formed from a uniform material or also using different materials.

For example, electrical conductor tracks can thus also be present on or in the element in accordance with the invention and sensors/pick-ups, actuators as well as evaluation and control units can be electrically connected to them. Such conductor tracks can be made in the form of a metallization which can be formed in thin film technology, known per se, and in a structured form. Conductor tracks can, however, also be printed on in a somewhat thicker manner, which is possible, for example, with an electrically conductive adhesive.

Such electrical conductor tracks can, however, also form antennas in addition to satisfying the function of establishing a conductive connection. The possibility of a wireless transfer of information exists with such antenna, e.g. together with an ASIC. Measured signals detected, for example, with sensors/pick-ups, can thus, for example, be transmitted in a wireless manner, as is possible in RFID engineering.

However, a transmission of electrical energy can also be achieved via antennas if, for example, an external transmission coil transmits electromagnetic radiation and an inductive electrical energy transmission is possible by a conductor track structure then made as a receiver antenna at an element.

A constant supply with electrical energy is also required for a use of elements in accordance with the invention for certain individual cases. In this connection, a suitable electrical energy store can be present at an element, with which there is preferably the possibility of recharging it, as explained above.

However, a replaceable electrical energy store can also be used which can then be connected to a suitable conductor track structure.

In addition to the already mentioned elements, functional elements and modules, optical display elements (displays) and operating elements can also be present. Electrical connections/contacts for separate electronic components and/or feed lines can also be present. They should be arranged on the side remote from the pimple-shaped elevated portions and should optionally be connected thereto in an electrically conductive manner.

Sensors/pick-ups with which stretching or deforming actions can be detected can be received in or integrated in a carrier layer which is connected to the electronic element.

With a conductor network integrated in a textile material, at least one element in accordance with the invention can be connected via electrical connections or in an electroplated manner.

Pimple-shaped elevated portions can also be formed at at least two sides at an element in accordance with the invention. There is thereby the possibility of a self-adhesive fastening to two adhesive bodies, with one of the adhesive bodies being able to be the skin surface of a living being and another adhesive body being able to be the textile material of articles of clothing. The pimple-shaped elevated portions can advantageously be made as elements at oppositely disposed sides. The possibility thereby opens up of being able to connect an element to a further element in a self-adhesive manner, which then so-to-say form a stack. The connection can be achieved by the force transmitting connection and the shape matched connection of the pimple-shaped elevated portions. Individual pimple-shaped elevated portions doped in an electrically conductive manner can form an electrically conductive connection.

However, with the presence of pimple-shaped elevated portions at least two sides, a plurality of elements in accordance with the invention can also be used next to one another and connected in a row or even in an array arrangement on an adhesive body.

The pimple-shaped elevations should preferably have a radius of curvature in the range from 2 to 5 mm and a spacing from one another which is at least so large that their circular bottoms, or also their bottoms of a different shape just contact one another with pimple-shaped elevated portions arranged adjacent to one another. However, differently dimensioned and differently shaped elevated portions can also be present at an element in accordance with the invention and can also have curvatures of radius differing from one another.

Certain regions of an element can also not have any pimple-shaped elevated portions, with this preferably being able to be the case in regions in which electrodes, sensors/pick-ups, light sources or other electronic elements are arranged.

An element in accordance with the invention can, however, also be integrated in a textile material and/or be detachably or non-detachably connected to such a material. However, this should then take place such that the surface regions at which pimple-shaped elevated portions remain freely accessible and an element can be fastened to adhesive bodies in a self-adhesive manner. A non-detachable connection or integration can be of a firmly bonded type, can, for example, be achieved by adhesive bonding or welding. This is possible in a simple form and with a sufficiently high strength on the use of polymer materials.

Due to the possibility for the self-adhesive fastening using viscoelastic, thixotropic or elastomeric pimple-shaped elevated portions, no residues remain on a surface of adhesive bodies after the removal of the elements, independently of whether the pimple-shaped elevated portions are made continuously (completely) of viscoelastic, thixotropic or elastomeric material or whether mixed arrangements of all or at least two of these materials are present.

With a suitable housing, optionally with an additional bolstering, the most varied integrated electrical, electronic or optoelectronic elements can be permanently and reliably protected against moisture and other unwanted influences. They can be cleaned and disinfected after use and can be exposed to high chemothermal or mechanical stresses in this connection and then subsequently be used again. The demands are also satisfied on reuse under extreme environmental influences such as heat, cold, tropical climate and polar climate, relative humidity, humidity, air pressure (altitude suitability) and body perspiration without the properties having been negatively influenced.

The impairment of living beings to whom such elements can be fastened in a self-adhesive manner is also negligible and the problems caused in the solutions of the prior art and disadvantageous effects can be completely avoided.

Elements in accordance with the invention can be dimensioned in small formats by the possible miniaturized layer structure, with in particular an achievable, very shallow design, a small inherent mass and flexible shape adaptability having an advantageous effect. They can moreover be made available in the most varied modifications in that an adaptation of the electrical and electronic or optoelectronic properties with suitable integrated elements is possible.

In comparison with conventional technical means, the manufacturing costs are also only slightly increased, if at all, in particular by the possibility of mass production.

A long-time use is also possible in which, if necessary, a change of the position of the fastening site at the respective adhesive body can also be made very easily and in a brief time. Additional means for the fastening are no longer necessary. The self-adhesive effect is sufficiently large such that an unwanted detaching can also be avoided with suddenly acting accelerations of the adhesive body.

As already addressed, a use can also be possible with dry or moist environmental conditions and with changing environmental conditions. In the medical field, body odors such as perspiration, or also splashed water and even bodily hair, do not have an unfavorable action on the self-adhesive effect and thereby also not significantly on the impedance behavior of an element worn on the body of a living being.

On a use on a living being, optionally a carrier layer and a housing, biocompatible materials or substances can be used for the manufacture, at least for the forming of pimple-shaped elevated portions, and avoid a disadvantageous effect, for example an allergic effect.

The invention will be explained in more detail by way of example in the following.

There are shown:

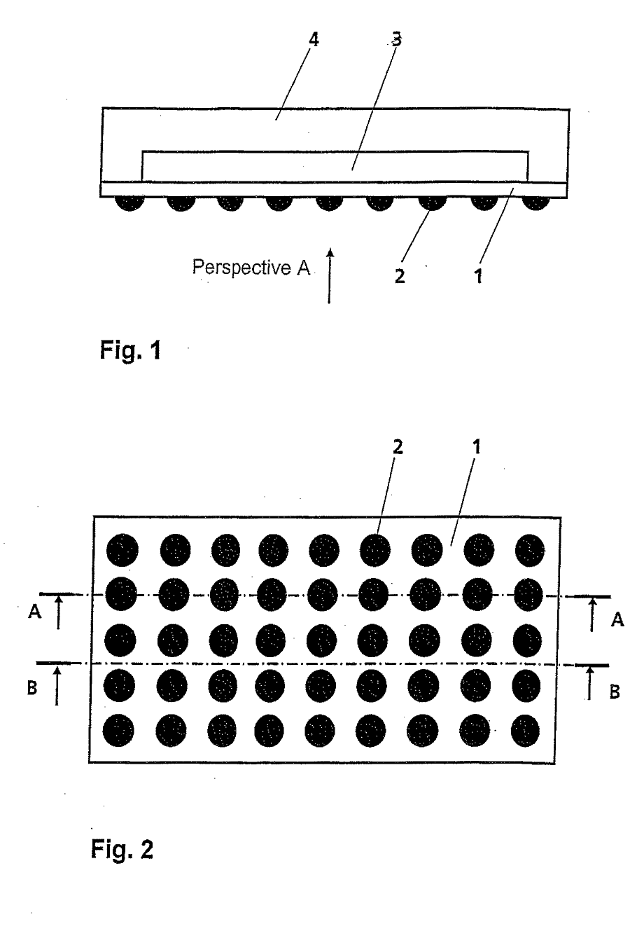

FIG. 1 a sectional representation through an example of an element in accordance with the invention at a section A-A in accordance with FIG. 2;

FIG. 2 a view A of the example shown in FIG. 1 from the side at which pimple-shaped elevated portions are formed;

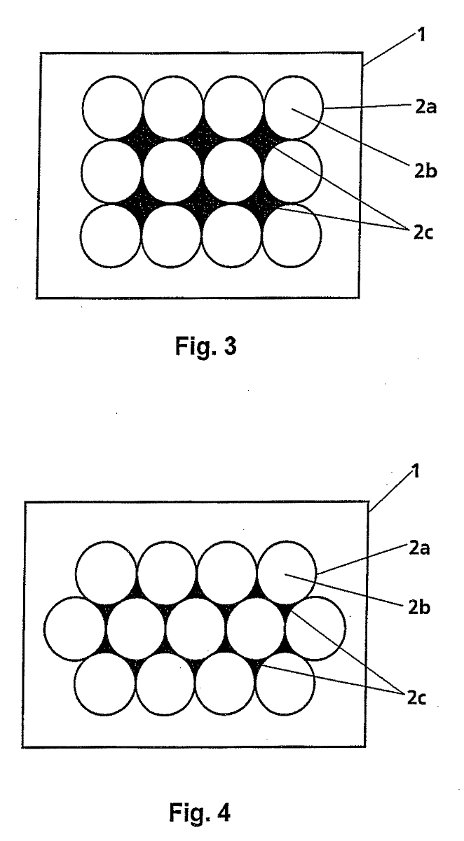

FIG. 3 a straight-line arrangement of pimple-shaped elevated portions with a linear arrangement of intermediate pimple chambers;

FIG. 4 pimple-shaped elevated portions in an offset arrangement and in intermediate pimple chambers arranged in rosette form;

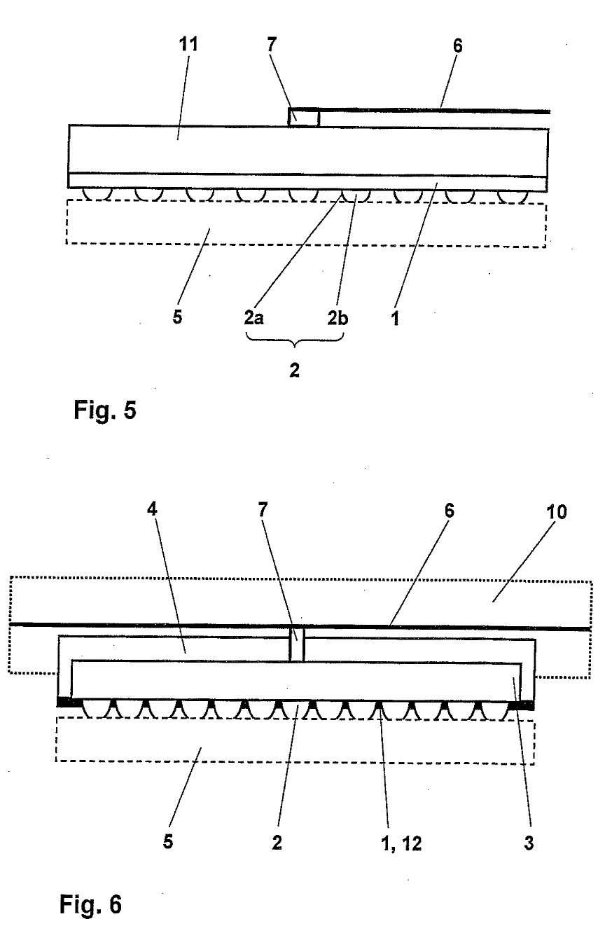

FIG. 5 a representation in section of an element in accordance with FIGS. 1 and 2 which is fastened to an adhesive body in a self adhesive manner, in accordance with section A-A of FIG. 2;

FIG. 6 a sectional representation of a further example of an element in accordance with the invention with textile integration which is fastened to an adhesive body in a self-adhesive manner;

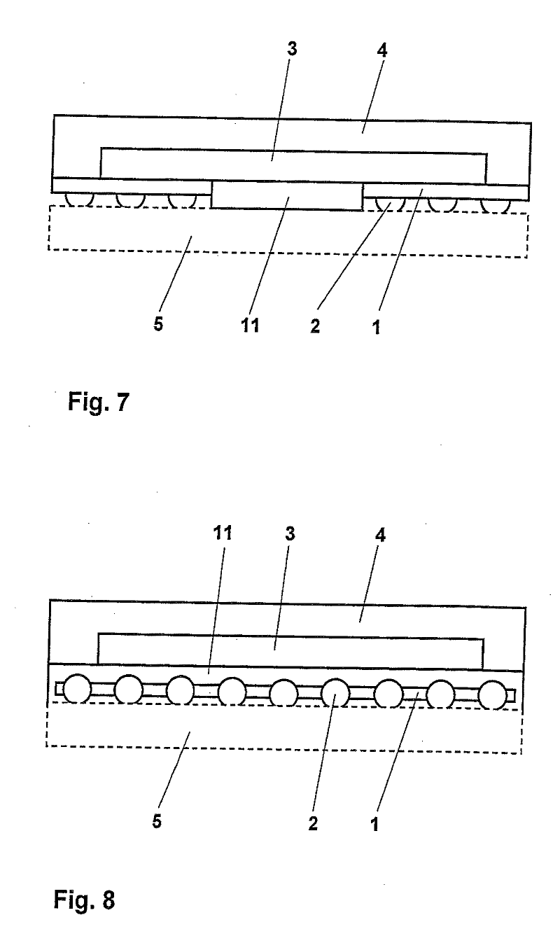

FIG. 7 a fourth example which is likewise fastened in a self-adhesive manner to an adhesive body, in accordance with section B-B from FIG. 2;

FIG. 8 a fifth example having a pimple framework integrated in a dry electrode and fastened to an adhesive body in a self-adhesive manner;

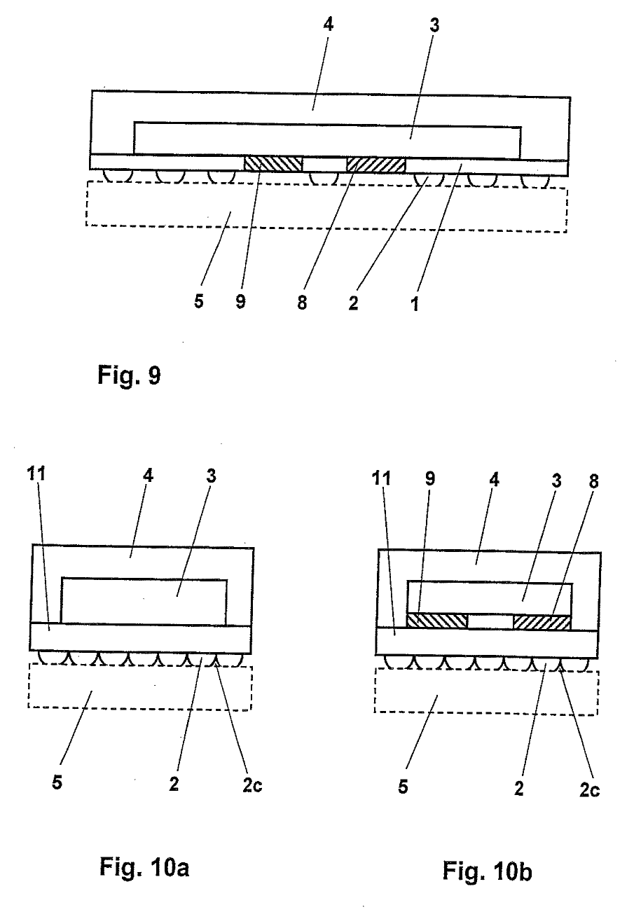

FIG. 9 a sixth example with integrated optoelectronics that is fastened to an adhesive body in a self-adhesive manner;

FIG. 10a a further example with a self-adhesive dry electrode and intermediate pimple chambers, without a carrier layer;

FIG. 10b an example in accordance with FIG. 10a with additional optoelectronics;

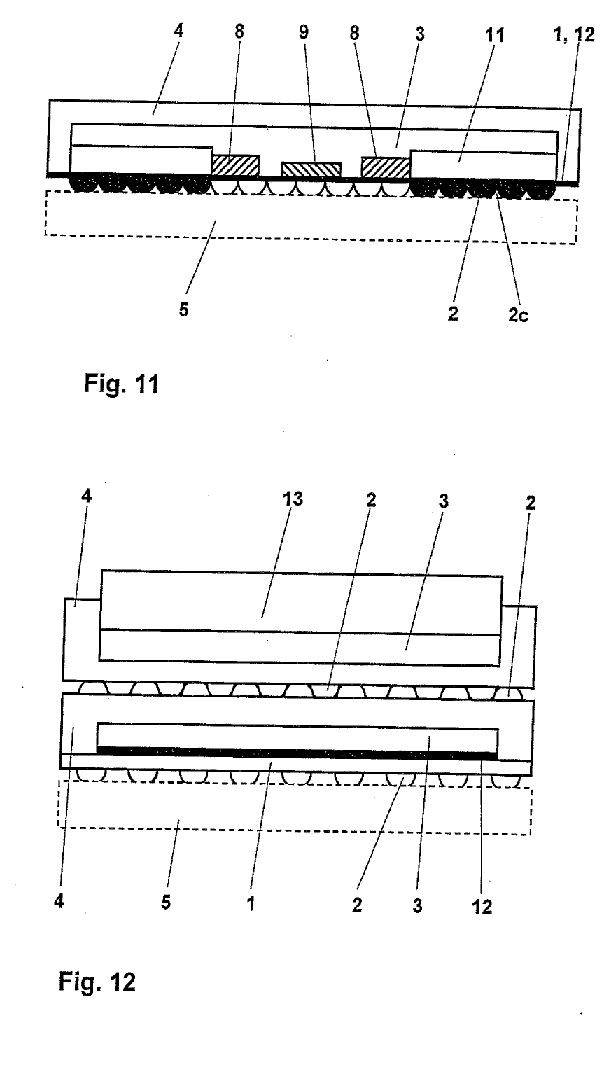

FIG. 11 a compact element as a further example with a plurality of integrated functional units, sensor/pick-up and intermediate pimple chambers; and

FIG. 12 two elements which are fastened to one another and then together to an adhesive body in a self-adhesive manner with integrated sensor/pick-up and actuator.

A basically possible structure of an element is shown in FIG. 1 which can be fastened to an adhesive body 5, not shown, in a self-adhesive manner and which can be made as an extracorporeal sensor with an integrated electronic element 3, e.g. in the form of a transponder. Pimple-shaped elevated portions 2, whose surface is spherically curved, are located an a preferably optically transparent and flexibly deformable carrier layer 1. The pimple-shaped elevated portions 2 can be made with electrically conductive graphite doping. They permit a self-adhesive effect at adhesive bodies, in particular for medical purposes at skin surfaces of living beings, and e.g. electrical currents can thereby be guided from the skin surface via the electrically conductive pimple-shaped elevated portions 2 or electrical currents can thereby be transmitted for therapeutic purposes.

As is shown schematically in FIG. 1, an electronic element 3 is arranged at the side of the carrier layer 1 which is disposed opposite the side at which the pimple-shaped elevated portions 2 are present. A rigid/flexible embodiment of the electronics, e.g. by means of a flexible circuit board, can in this connection permit a completely flexible adaptation to the respective body surface. A housing 4, e.g. in the form of a polymer seal or of an elastomeric grouting, is provided as protection of electronic elements 3. The electronic element 3 or also optionally further electronic or electrical elements can thus be kept hermetically closed and a sufficient flexible deformability can nevertheless be ensured. A non-damaging cleaning and disinfection is also possible.

In addition to the electronic element 3, further operating elements and/or functional elements such as light emitting diodes 8 or also photocells for the energy supply can be present under an elastomeric optically transparent housing 4 which is made e.g. as a grouting mass. The carrier layer 1 can act in the most simple form only as a carrier of the pimple-shaped elevated portions 2 arranged spaced apart here and can be made of the same material or of a material different thereto. Other functions such as heat conduction can be enabled in addition to the electrical conductivity.

A direct, sealing bond is present between the housing 4 and the carrier layer 1 at the rims surrounding the electrical or electronic or optoelectronic elements 3. The stabilization of the carrier layer 1 with the pimple-shaped elevated portions 3 can be achieved by the electronic element 2 or by the housing 4 or also by its structure itself (pimple structure).

A communication with other sensors/pick-ups or with an electronic evaluation and control unit can take place in a wireless manner by means of electromagnetic waves such has already been explained in the general part of the description.

With the exception of the electronic element 3, no further integration elements, an electrical contact or other contacts or connections are shown in FIG. 1. A sensor/pick-up 12 could be present additionally to or instead of the electronic element 3.

In accordance with view A of FIG. 1, FIG. 2 shows the pimple-shaped elevations 2, which, as shown in FIG. 1, are arranged at a spacing from one another, at the lower side of a carrier layer 1 of an element adhering e.g. to a body of a living being as an adhesive body 5. The pimple-shaped elevations 2 in this example are exclusively locally concentrated viscoelastic elevated portions which are preferably arranged on the carrier layer in an optically transparent and wear-resistant manner and are electrically conductive. The pimple-shaped elevated portions 2 are arranged in a regular distribution here and each have the same geometrical shape and radii. There is, however, the possibility of adapting these geometrical parameters to the respective surfaces of adhesive bodies 5 not shown here.

When an element is applied and pressed on once, a deformation takes place of at least the pimple-shaped elevated portions 2, which can have either a convex or a concave base shape, which is, however, reversible after the detaching of an element from the adhesive body 5, that is, the starting shape is adopted again. No residues remain on the surface of the adhesive body 5 in this connection.

If additional contacts 7, not shown here, are provided in pimple-shaped elevated portions 2 and/or in the carrier layer 1 and are connected here to the electronic element, but can also be connected to a sensor/pick-up 12, they can have a platelet shape, a cylindrical shape or a ring shape.

FIG. 3 shows an arrangement of pimple-shaped elevated portions 2 in which all the pimple-shaped elevated portions 2 contact one another at their pimple interface layers 2a which close the base pimple body 2b.

A free space thereby arises which, as an intermediate pimple chamber 2c is enclosed and sealed by the pimple-like elevated portions 2. The pimple-shaped elevated portions 2 and the intermediate pimple chambers 2 are arranged in rows. The pimple-shaped elevated portions 2 contact one another at least at points at their pimple bases or at their starting base to the carrier layer 1 and can also contact one another in a linear section.

On application, the pimple-shaped elevated portions 2 deform such that the seal at the pimple contact sites is amplified and each intermediate pimple chamber 2c acts as an additional suction pad. In this connection, during the deformation of the contacting pimple-shaped elevated portions 2, due to their axial pressure onto the adhesive body, the intermediate pimple chambers 2c in each case having a suction head closed in itself are formed and/or sealed by the pimple-shaped elevated portions 2 being under radial pressure during the deformation.

In this connection, these additional suction pads form a tight adhesive force network with the pimple-shaped elevated portions 2. This results in a full-area adhesive effect by suction and adhesion forces so that the adhesion of the element at the adhesive body 5 is amplified.

FIG. 4 shows an arrangement of pimple-shaped elevated portions 2 with an offset at which, as also in the example of FIG. 3, the pimple-shaped elevated portions 2 contact one another. The intermediate pimple chambers 2c formed in this connection have a smaller suction surface with respect to the arrangement in rows along a line in accordance with the example of FIG. 3. However. more suction pads or suction heads are present by a rosette-shaped arrangement of the intermediate pimple chambers 2.

An example of an element is shown in FIG. 5 which can be used as a dry electrode 11 in a self-adhesive manner. This example can be used as an extracorporeal element. The electrical conductivity can also be achieved with graphite doping here. The doping does not influence the self-adhesive effect.

The carrier layer 1 in this example is made from the same material as the pimple-shaped elevated portions 2. The doping and the consistency coincide, with this, however, also being able to be different from one another.

It is addressed in detail in FIG. 5 that viscoelastic pimple-shaped elevated portions 2 can be formed with a base pimple body 2b and an interface layer 2a which can be present at or formed with a likewise viscoelastic carrier layer 1. Pimple-shaped elevated portions 2 can in this connection be formed directly at the carrier layer 1, but can also be connected in a non-detachable elastically deformable manner to the carrier layer 1. They effect partial suction processes on the deformation of pimple-shaped elevated portions 2. A negative pressure builds up between the surface of an adhesive body 5 and the intermediate layer 2a. In addition, intermolecular adhesion forces act at the phase interfaces and come into effect, as attraction forces between atoms or molecules of the interface layer 2a as well as of the carrier layer 1, as static friction with the surface of the adhesive body 5 on their contact. Both adhesive effects mutually support one another and effect the self-adhesive fastening possibility of elements. In the embodiment, the pimple-shaped elevated portions 2 have a spherical form.

In the further examples to be described in the following, a reference to and the representation of an embodiment of pimple-shaped elevated portions 2 with interface layer 2a and base pimple body 2b have been omitted even though such an embodiment is naturally also possible in these examples.

As already addressed, pimple-shaped elevated portions 2 and the carrier layer 1 can be doped with electrically conductive particles so that they are likewise thereby electrically conductive and a direct electrical coupling to an electrically conductive adhesive body 5 is possible.

In the form shown, a concave base arching can be present which can extend over the total carrier layer 1. The suction effect can thereby be increased or supported on a self-adhesive fastening.

In an embodiment of an element in accordance with the invention as an adhesive electrode 11 having two layers, an adhesive layer and an electrode layer, a use can take place e.g. in the medical field. An electrically conductive carrier layer 1 having the electrically conductive pimple-shaped elevated portions 2 can in this case be arranged directly below the actual electrode 11 and can be connected thereto in an electrically conductive manner by means of electrically conductive adhesive, for example. A contact 7 for the connection of an electrical line 6 is shown schematically in FIG. 5. The pimple-shaped elevated portions 2 are in direct contact with a human body as an adhesive body 5. Contrary to the representation, however, electrically conductive pimple-shaped elevated portions 2 can be connected directly, that is without a carrier layer 1, to a dry electrode 11 or can be its direct component (see FIGS. 10a and 10b).

Furthermore, for the further modification of pimple-shaped elevated portions 2 for a reinforced design of the Van-der-Waals force, its surface can be equipped with a plurality of very fine hairs, which are not shown here.

An element with textile integration is shown in FIG. 6 which is fastened with self-adhesion and wherein the carrier layer 1 is made in mesh form or screen form and accepts the pimple-shaped elevated portions 2. The mesh of the carrier layer 1 can be of honeycomb shape, round or prismatic and can additionally act as a sensor/pick-up 12. In this connection, electrical signals can be provided e.g. from changes in resistance caused by stretching of the mesh. Self-adhesive elements with such receivers 12 can e.g. be used in medicine for monitoring of exertion breathing. In other embodiments, the sensors/pick-ups 12 can also serve the detection of pulse pressure or blood pressure. The network of the carrier layer 1 has a stabilizing effect and is filled by pimple-shaped elevated portions 2 which project out of it at one side.

In other embodiments, the carrier layer 1 can be made of the same material as the pimple-shaped elevated portions 2. In this connection, the pimple-shaped elevated portions 2 can e.g. have a different consistency than the carrier layer 1. Furthermore, a housing 4 can be present, here made as an elastomeric grouting. The grouting can likewise consist of the same material.

An electrically conductive connection to an electronic element 3 is possible via the contact 7 to the electrical line 6 which can be located in a textile part 10. In this connection, only the electrical line 6 and a contact 7 are shown in FIG. 6. However, there is also the possibility of arranging an electrical line 6 inside the housing 4 or to form it therein.

The contact of electrically conductive pimple-shaped elevated portions 2, including the sensor/pick-up 12 with the electronic element 3, is realized by electrically conductive adhesive. A shape matched and/or force transmitting contact, optionally with additional mating contacts, can, however, also be present.

An adhesive body 5 can, for example, be a human body whose skin surface can be contacted directly using an element in accordance with the invention.

A self-adhesive fastening is, however, also possible on other adhesive bodies 5 which have a fixed, rigid surface to which an element can be fastened in a self-adhesive manner.

In all representations, the pimple-shaped elevated portions 2 are shown such that they have a deformation on fastening, independently of whether their base shape is convex or concave.

An element is shown in FIG. 7 in which a dry electrode 11, e.g. for ECGs, is connected directly to the carrier layer 1 laterally on which the pimple-shaped elevated portions 2 are formed. The dry electrode 11 is embedded into a carrier layer 1 with pimple-shaped elevations 2 in this connection. An electronic element 3 is connected to the dry electrode 11. In this connection, the dry electrode 11 can, however, also be electrically contacted with a further connection in a manner not shown here.

Pimple-shaped elevated portions 2 and a carrier layer 1 can be electrically conductive in another form and can improve the impedance relationships of the dry electrode 11 with the adhesive body 5 if they are arranged directly below the dry electrode 11 (see FIGS. 10a and 10b). In the representation of FIG. 7, the carrier layer 1 and the pimple-shaped elevated portions 2 are formed such they are not electrically conductive. The electronic element 3 is shown without any electrical contact.

The electronic contact element 3 can stabilize the flexible carrier layer 1. The dry electrode 11 and the electronic element 3 are provided with the housing 4 which likewise stabilizes the carrier layer 1. In this example, the adhesive body 5 can also be a human body to which electrical currents in the form of pulses for the stimulation of muscles and nerves or electrical energy, e.g. for defibrillation, can also be transmitted.

In the example shown in FIG. 8, a dry electrode 11 is shown with the pimple-shaped elevated portions 2 deformed on the fastening in the state fastened to the adhesive body 5. The pimple-shaped elevated portions 2 are connected to the carrier layer 1 which is here designed in net form as a pimple frame so that the electrode material can pass through. The spherical shape of the pimple-shaped elevated portion 2 in conjunction with the carrier layer 1 and the symmetrical arrangement shown here ensures a relatively large material reservoir so that a good adhesive contact on the surface of the adhesive body 5 can be achieved with optimum self-adhesive effect.

To improve the impedance conditions, the pimple-shaped elevated portions 2 and the carrier layer 1 are made electrically conductive. The dry electrode 11 and the electronic element 3 are also enclosed in a housing 4 in this example.

In the example of FIG. 9, a light source 8 and also a photodetector 9 are present at the element in the carrier layer 1. Pimple-shaped elevated portions 2 are again present on the side of the carrier layer 1 facing the surface of the adhesive body 5. The electronic element, which can also be provided with an electrical energy supply for the light source 8 and the photodetector 9, is arranged at the oppositely disposed side of the carrier layer 1. The electronic element 3 is provided for this purpose with a suitable electrical contact which is not shown here. Furthermore, further functional elements, operating elements and display, which are likewise not shown, can be arranged in/on the element.

With optically transparent pimple-shaped elevated portions 2, they can be arranged directly below the light source 8 and the photodetector 9 (see FIG. 10b and FIG. 11). A human body on which an element can be fastened to the skin in a self-adhesive manner can also be provided as the adhesive body 5 here.

In other embodiments having different light sources, e.g. OLEDs or lasers, however, different structures, assemblies or arrangements are also possible. The photodetector 9 and the light source 8 can thus, for example, be arranged above the carrier layer 1 or a combination comprising the light source 8 and the photodetector 9 can be provided in a unit at an element in accordance with the invention and/or be integrated directly into the electronic unit 3.

The communication takes place in wireless manner in this example and can be realized in wired manner in other embodiments.

The element is here likewise provided with a housing 4.

FIG. 10a shows, in a modification of the example of FIG. 7, a self-adhesive element having a dry electrode 11. Pimple-shaped elevations 2 form intermediate pimple chambers 2c for the generation of additional suction forces and are fastened directly to the dry electrode 11 without a carrier layer 1. The dry electrode 11 and the pimple-shaped elevated portions 2 are here made from the same electrically conductive material. The adhesive body 5 can be a human body. An electronic element 3 which can also communicate with other elements in a wireless manner adjoins the dry electrode 11. A housing 4 is also present in this example.

FIG. 10b shows, in a modification of the example of FIG. 10a and in combination with FIG. 9, a self-adhesive element having a dry electrode 11 which is provided with pimple-shaped elevated portions 2 facing the adhesive body 5 and which likewise has no carrier layer 1. The dry electrode 11 and the pimple-shape elevated portions 2 are made optically transparent. A light source 8 and a photodetector 9 are arranged above the light permeable dry electrode 11 and the electronic element 3 adjoins them. The element is protected by the housing 4.

The optically transparent pimple-shaped elevated portions 2 contact one another and form intermediate pimple chambers 2c.

This arrangement allows both body signals and plethysmographic signals to be discharged.

If, as in the examples of FIGS. 10a and 10b, pimple-shaped elevated portions 2 made electrically conductive are arranged perpendicular below an electrode 11 or a sensor/pick-up 12, this construction size of an element can be further reduced.

With such a vertical arrangement, the electrode 11 can also be replaced by a sensor/pick-up 12 detecting vibrations, with electrically non-conductive pimple-shaped elevated portions 2 being present.

If, however, there is a demand for a direct contact of the electrode 11 or the sensor/pick-up 12 to the adhesive body 5 without pimple-shaped elevated portions 2 arranged therebetween, they should be arranged in accordance with the example of FIG. 7 laterally next to the electrode 11 or the sensor/pick-up 12. The connection between one another can take place by grouting, welding or adhesive bonding. Special impedance demands can be satisfied with such a horizontal arrangement.

However, hybrid elements can also be formed with a combination of an arrangement of pimple-shaped elevated portions 2 selected perpendicular to and laterally beside the electrode 11 and/or the sensor/pick-up 12.

In a further embodiment, an element can also be protected from water, liquids or other influences in the adhesive region by at least one electrically non-conductive pimple-shaped elevated portion 2 and can be hermetically sealed in the adhesive position. In this connection, such a pimple-shaped elevated portion 2 can be adapted to the outer rim contour and can form a closed ring contour or also a border.

FIG. 11 shows, in a modification and combination of the examples in accordance with FIGS. 10 and 9, an element having self-adhesion to the adhesive body 5 and having mutually contacting pimple-shaped elevated portions 2 which form intermediate dimple chambers 2c and adjoin a dry electrode 11 at their carrier layer 1, with the pimple-shaped elevated portions 2 being optically transparent and an photodetector 9 and two light sources 8 being arranged in the concentric cut-out of said dry electrode.

The carrier layer 1 is, as in the example of FIG. 6, simultaneously made as a sensor/pick-up 12 and can include strain gages, wire turns or also temperature sensors.

The electronic element 3 is arranged above the dry electrode 11, the photodetector 9 and the light source 8 in the representation. A housing 4 is also present here.

In other embodiments, the dry electrode 11 can also be arranged centrally around which a plurality of optoelectronic elements, e.g. plethysmographic units, metabolic spectroscopes, photodetectors 9 and light sources 8 can be arranged. In this connection, different wavelengths can be selectively taken into account.

In the example shown in FIG. 12, two elements in accordance with the invention are connected to one another in stacked form. In this connection, dimple-shaped elevated portions 2 are formed at the lower element at a side facing in the direction of the surface of an adhesive body 5 and said element can be fastened to the adhesive body 5 in a self-adhesive manner with the help of said dimple-shaped elevated portions. On the oppositely disposed side of the here lower element, pimple-shaped elevations 2 are likewise formed with which the element arranged at the bottom here can be connected to the element arranged above it likewise in a self-adhesive manner and both can be fastened to one another. In this connection, the force transmitting connection can be supported by the shape matched connection of the dimple-shaped elevated portions 2.

The element shown at the bottom here is provided with an electronic element 3, with the representation of a contact or of connections having been omitted here. It can be connected as an extracorporeal sensor element to a human body as an adhesive body 5 or also in a self-adhesive manner to other objects.

The pimple-shaped elevated portions 2 which are present at the element shown at the bottom here can be made of the same material as the carrier layer 1, which can also apply to the housing 4.

In this embodiment, the dimple-shaped elevated portions 2 and the carrier layer 1 are made electrically conductive.

In addition, in the electronic unit 3 shown at the bottom here a sensor/pick-up 12 is arranged which can be connected to microsystem engineering components.

The element shown at the top here can be provided with a so-called transponder and the communication from electronic elements 3 can then take place via integrated radio modules. Partial sensor systems (e.g. stack systems) can thereby be formed or also other systems can be connected together next to one another in a plane with further elements. A variable expansion and practically any desired expansion of a sensor system formed from a plurality of elements in accordance with the invention is thus possible.

In addition, in the element shown at the top here, an actuator 13 is present which is controlled via the upper electronic element 3. In this connection, this actuator 13 contains microfluidic elements which cooperate in chambers, not shown, and can trigger a mechanical movement or a shape change.

The sensor/pick-up 12 in the element shown at the bottom here can detect muscle movements, with the signals being processed in a lower electronic element 3 and triggering an actuator function in the actuator 13 by means of a radio module which can cooperate with a radio module of the electronic element 3 of the element shown at the top here.

In another embodiment, a micromechanical actuator 13 can be present instead of a microfluidic actuator 13 and the element shown at the top here can be supplemented by a display, a photocell or the like.

An adhesive prosthesis can be formed for medical applications in this form having a sensor/pick-up and actuator function, with the elements in accordance with the invention also being able to be fastened to any other desired body sites in addition to the shown stack arrangement.

### REFERENCE NUMERAL LIST

1 carrier layer
2 pimple-shaped elevation
2a pimple interface layer
2b base pimple body
2c intermediate pimple chamber
3 electronic element
4 housing
5 adhesive body
6 electrical line
7 contact
8 light source/light emitting diode/OLED/laser light source
9 photodetector
10 textile part
11 dry electrode/electrode/adhesive electrode
12 sensor/pick-up
13 actuator

1. A self-adhesive element for attachment of at least one of a sensor, a pick-up, an electronic element, an optoelectronic element and an actuator in a self-adhesive and detachable manner to a body, the self-adhesive element having elastically deformable pimple-shaped elevated portions whose surfaces are spherically curved at least in the region which is in touching contact with the body; wherein the pimple-shaped elevated portions are made with a material which has at least one of viscoelastic properties, thixotropic properties and elastomeric properties.

2. An element in accordance with claim 1 wherein the surfaces of the pimple-shaped elevated portions are convexly spherically curved.

3. An element in accordance with claim 1 wherein the surfaces of the pimple-shaped elevated portions are concavely spherically curved.

4. An element in accordance with claim 1 wherein at least some of the pimple-shaped elevated portions have convexly curved surfaces and at least some of the pimple-shaped elevated portions have concavely curved surfaces.

5. An element in accordance with claim 1 further including a pimple interface layer formed on the surfaces of the pimple-shaped elevated portions.

6. An element in accordance with claim 1 wherein the pimple-shaped elevated portions are formed with base pimple bodies which are surrounded by pimple interface layers.

7. An element in accordance with claim 6 wherein the pimple interface layers are formed in a skin-like manner.

8. An element in accordance with claim 1 wherein hairs are formed at the surfaces of the pimple-shaped elevated portions.

9. An element in accordance with claim 1 wherein the body is one of a body of a living being, a rigid body, a flexible material and a textile material.

10. An element in accordance with claim 1 wherein the pimple-shaped elevated portions are doped with an electrically conductive material such that they are electrically conductive.

11. An element in accordance with claim 1 wherein the pimple-shaped elevated portions include at least one of fillers, gels, pigments and gases.

12. An element in accordance with claim 1 wherein the pimple-shaped elevated portions are at least one of formed at a carrier layer and connected to the carrier layer.

13. An element in accordance with claim 12 wherein the carrier layer is doped in at least certain regions with an electrically conductive material.

14. An element in accordance with claim 12 wherein the carrier layer is at least one of made in the manner of a foil, formed from a pimple carrier frame, constructed in net form, constructed in screen form, constructed in ring form and constructed in honeycomb form.

15. An element in accordance with claim 12 wherein the pimple-shaped elevated portions are embedded at least one of symmetrically into the carrier layer and centrally into the carrier layer.

16. An element in accordance with claim 12 in which the pimple-shaped elevated portions at least one of project out of the carrier layer at one side and are arranged on one side of the carrier layer.

17. An element in accordance with claim 12 wherein the carrier layer is at least one of made as a sensor, made with a sensor, made as a pick-up, and made with a pick-up.

18. An element in accordance with claim 1 wherein the at least one of a sensor, a pick-up, an electronic element, an actuator, a light source and a photodetector is surrounded by a housing.

19. An element in accordance with claim 18 wherein the housing is made as at least one of a flexible grouting, a foil closure and a rigid encapsulation.

20. An element in accordance with claim 1 wherein the at least one of a sensor, a pick-up, an electronic element, a light source, a photodetector and an actuator is at least one of partly sealed, completely sealed and bolstered.

21. An element in accordance with claim 1 wherein the self-adhesive element for attachment of at least one of a sensor, a pick-up, an electronic element, an optoelectronic element and an actuator comprises a self-adhesive element for attachment of at least one of a sensor and a pick-up, the at least one of a sensor and a pick-up comprising at least one of an ohmic resistor, a thermal element, a vibration detector and a pressure detector.

22. An element in accordance with claim 1 wherein the self-adhesive element for attachment of at least one of a sensor, a pick-up, an electronic element, an optoelectronic element and an actuator comprises a self-adhesive element for attachment of an actuator having at least one of micro hydraulic components, micropneumatic components, micromechanical components and microoptical components.

23. An element in accordance with claim 1 wherein the self-adhesive element for attachment of at least one of a sensor, a pick-up, an electronic element, an optoelectronic element and an actuator comprises a self-adhesive element for attachment of at least one of a sensor, a pick-up and an actuator, the at least one of a sensor, a pick-up and an actuator being replaceable and including electrical and mechanical interfaces.

24. An element in accordance with claim 1 wherein the self-adhesive element for attachment of at least one of a sensor, a pick-up, an electronic element, an optoelectronic element and an actuator comprises a self-adhesive element for attachment of at least one of a sensor and a pick-up, the at least one of a sensor and a pick-up including extracorporeal devices which can be brought into connection with a body of a living being in at least one of an intravenous manner and an intra-arterial manner.

25. An element in accordance with claim 1 further including a reservoir for the reception of at least one of pharmaceutical active ingredients and liquids.

26. An element in accordance with claim 1 wherein the self-adhesive element for attachment of at least one of a sensor, a pick-up, an electronic element, an optoelectronic element and an actuator is at least one of firmly bonded to a carrier, attached to a carrier in a shape matched manner and attached to a carrier in a force transmitting manner.

27. An element in accordance with claim 1 further including at least one electrode.

28. An element in accordance with claim 27 wherein the at least one electrode is in touching contact with the body.

29. An element in accordance with claim 27 wherein the at least one electrode is connected to at least one of electrically conductive pimple-shaped elevated portions, electrical conductors, electrical contacts and an electronic element.

30. An element in accordance with claim 27 wherein the pimple-shaped elevated portions are embedded into a dry electrode.

31. An element in accordance with claim 1 wherein an adhesive region having pimple-shaped elevated portions and an electronic region having at least one of a sensor a pick-up, at least one electrode, an electronic element and an actuator are at least one of fixedly connectable to one another and detachably connectable to one another.

32. An element in accordance with claim 31 including a textile part arranged between the adhesive region and the electronic region.

33. An element in accordance with claim 1 wherein the pimple-shaped elevated portions are arranged in a vertical arrangement perpendicularly below at least one of an electrode, a sensor and a pick-up.

34. An element in accordance with claim 1 wherein the pimple-shaped elevated portions are arranged in a horizontal arrangement laterally beside the at least one of the at least one electrode, the sensor and the pick-up.

35. An element in accordance with claim 33 wherein the pimple-shaped elevated portions are present in a vertical and horizontal arrangement.

36. An element in accordance with claim 1 further including electrical conductor tracks.

37. An element in accordance with claim 36 wherein the electrical conductor tracks form an antenna.

38. An element in accordance with claim 1 further including at least one of an electrical energy store and a photocell (photovoltaic element).

39. An element in accordance with claim 1 wherein the pimple-shaped elevated portions are formed at least two flat sides of the element.

40. An element in accordance with claim 1 further including at least one of a light source and an optical detector.

41. An element in accordance with claim 40 wherein the at least one of a light source and an optical detector comprises a light source, the light source comprising at least one of a light emitting diode, an organic light emitting diode and a laser light source.

42. An element in accordance with claim 1 wherein the pimple-shaped elevated portions have a radius of curvature in the range from 2 to 5 mm.

43. An element in accordance with claim 1 wherein the pimple-shaped elevated portions are at least one of formed at a carrier layer and connected to the carrier layer, the element further including at least one electrode, and wherein at least one of the pimple-shaped elevated portions, the carrier layer and the at least one electrode is formed at least partly of an optically transparent material.

44. An element in accordance with claim 1 further including at least one of a display and operating elements.

45. An element in accordance with claim 1 made at least partly of an optically transparent material.

46. At least two elements constructed according to claim 1 connected to one another in a self-adhesive manner and arranged in at least one of the following two ways: overlapping next to one another; and, stacked one on top of the other.

47. An element in accordance with claim 1 connected to two bodies.

48. An element in accordance with claim 1 wherein the pimple-shaped elevated portions are formed at a carrier layer, the element including a copper lamination at the carrier layer and at least one of frame-shaped contacts, circular contacts and ring-shaped contacts formed with the copper lamination and electrically conductively connected to the pimple-shaped elevated portions which are electrically conductively doped.

49. An element in accordance with claim 48 electrically conductively doped pimple-shaped elevated portions are electrically conductively connected to one another, fixedly or detachably, via at least one of contacts, conductor tracks and electronic elements in at least one of a firmly bonded manner, a shape matched manner and a force transmitting manner.

50. An element in accordance with claim 6 wherein the base pimple body of the electrically conductive pimple-shaped elevated portions includes at least one of platelet-like contacts, cylindrical contacts and ring-shaped contacts flexibly embedded at a fastening side of the base pimple body.

51. An element in accordance with claim 50 wherein the contacts are fastened in the base pimple body by at least one of adhesive bonding, grouting and vulcanization.

52. An element in accordance with claim 1 wherein at least one electrically non-conductive pimple-shaped elevated portion is formed, following an outer rim contour of the element, and forming a boundary.

53. An element in accordance with no pimple-shaped elevated portions are present in regions of the element in which the at least one of a sensor, a pick-up, an electronic element, an optoelectronic element and an actuator is arranged.

54. An element in accordance with claim 1 comprising pimple-shaped elevated portions arranged in a radially outer enclosure around an inner region without pimple-shaped elevated portions.

55. An element in accordance with claim 1 at least one of integrated into a textile material integrated into a flexible material fixedly connected to a textile material, fixedly connected to a flexible material, detachably connected to a textile material and detachably connected to a flexible material.

56. An element in accordance with claim 1 including a textile part, and external electrical lines in the form of a conductor network integrated into the textile part.

57. (canceled)

58. An element in accordance with claim 1 wherein at least one of intermolecular adhesive forces (Van der Waals force) and suction forces acts between the surface of pimple-shaped elevated portions and the body surface.

59. An element in accordance with claim 26 wherein at least one of a sensor, a pick-up, an actuator, an electrode, a photodetector, a light source and an electronic element is arranged on a flexible carrier.

60. An element in accordance with claim 59 wherein the flexible carrier comprises at least one of a rigid circuit board, a flexible circuit board, rigid circuit board parts connected to one another with flexible connection elements, and flexible circuit board parts connected to one another with flexible connection elements.

61. An element in accordance with claim 59 further including a carrier layer, the carrier is at least one of electrically conductively connected to the carrier layer and electrically conductively connected to the pimple-shaped elevated portions.

62. An element in accordance with claim 1 wherein the pimple-shaped elevated portions are at least one of arranged next to one another in a row, arranged next to one another in columns, arranged next to one another in lines, arranged next to one another forming rings and arranged next to one another forming arcs.

63. An element in accordance with claim 1 wherein the pimple-shaped elevated portions contact one another at least one of their pimple bases and their starting roots to the carrier layer and form intermediate pimple chambers.

64. An element in accordance with claim 63 wherein the intermediate pimple chambers are formed as at least one of suction chambers and suction heads.

65. An element in accordance with claim 63 wherein the intermediate pimple chambers are formed as cut-outs.

66. An element in accordance with claim 63 wherein the at least one of the pimple bases and starting roots to the carrier layer of pimple-shaped elevated portions has a geometrical form which is at least one of circular, elliptical, prismatic and honeycomb shaped.

67. An element in accordance with claim 1 wherein adjacent pimple-shaped elevated portions are connected to one another in a firmly bonded manner to form a carrier layer.

68. An element in accordance with claim 1 wherein adjacent pimple-shaped elevated portions have different spacings from one another.

69. An element in accordance with claim 1 further including a carrier layer, the carrier layer being concavely arched at least regionally in a direction of a surface of a body.
